(19) United States
(12) Patent Application Publication
(10) Pub. No.: US 2010/0151204 A1
(43) Pub. Date: Jun. 17, 2010

(54) Light diffusion film and method for manufacturing the same

(76) Inventors: Jin Woo Lee, Uiwang-si (KR); Bang Duk Kim, Uiwang-si (KR); Sei Jin Oh, Uiwang-si (KR); Chang Gyu Im, Uiwang-si (KR); Sun Ae Hwang, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/659,215

(22) Filed: Mar. 1, 2010

Related U.S. Application Data
(63) Continuation of application No. PCT/KR2007/007011, filed on Dec. 31, 2007.

(30) Foreign Application Priority Data
Aug. 28, 2007 (KR) 10-2007-0086601

(51) Int. Cl. B32B 3/30; B29C 43/24; B24C 1/00

(52) U.S. Cl. 428/156; 264/175; 451/38

(57) ABSTRACT

A light diffusion film includes a thermoplastic resin, wherein a surface of the light diffusion film has an embossed pattern thereon, and the surface of the light diffusion film having the embossed pattern has a surface roughness (Ra) of about 0.5 μm to about 3 μm and a height distribution index (HDI) of about 3 μm to about 8 μm.

### CROSS-REFERENCE TO RELATED APPLICATION

This application is a continuation of pending International Application No. PCT/KR2007/007011, entitled “Light Diffusion Film Having Good Uniformity of Surface Roughness and Method For Manufacturing The Same,” which was filed on Dec. 31, 2007, the entire contents of which are hereby incorporated by reference.

### BACKGROUND

1. Field

Embodiments relate to a light diffusion film and a method for manufacturing the same.

2. Description of the Related Art

Display devices such as liquid crystal display (LCD) devices may be equipped with a light diffusion film. The light diffusion film for an LCD device is usually used for transferring and diffusing light from a back light unit to a LCD panel. The light diffusion film may uniformly distribute light to an observer while maintaining the overall light transmittance, and may hide defects that may be generated by a light guide. Such a light diffusion film may be used in an LCD device for car navigation systems, cellular phones, PDAs, digital cameras, portable TVs, camcorders, small or medium to large notebook computers, monitors for desktops, etc.

Light diffusion films must overcome various problems. These problems may include lack of dimensional stability, coating defects caused by lack of durability in a coating process, scratch defects in a coating layer, non-uniformity of surface texture, dust adhesion derived from electrostatic generation, and reduced brightness or brightness non-uniformity caused by the above defects.

### SUMMARY

Embodiments are directed to a light diffusion film and a method for manufacturing the same, which substantially overcome one or more problems due to the limitations and disadvantages of the related art.

It is a feature of an embodiment to provide a light diffusion film having a surface roughness (Ra) of about 0.5 μm to about 3 μm and a height distribution index (HDI) of about 3 μm to about 8 μm.

At least one of the above and other features and advantages may be realized by providing a light diffusion film, including a thermoplastic resin, wherein a surface of the light diffusion film has an embossed pattern thereon, and the surface of the light diffusion film having the embossed pattern has a surface roughness (Ra) of about 0.5 μm to about 3 μm and a height distribution index (HDI) of about 3 μm to about 8 μm.

The light diffusion film may have a thickness of about 60 μm to about 450 μm.

The light diffusion film may have a haze of about 70% or greater and a total transmittance of about 88% or greater.

The thermoplastic resin may include at least one of a methacrylic resin, a styrene resin, a cycloolefin resin, and a polycarbonate resin.

At least one of the above and other features and advantages may also be realized by providing a method for manufacturing a light diffusion film, the method including providing a cooling roll having a sandblasted surface, the surface being sandblasted about four to about twelve times with an abrasive having a particle diameter of about 100 μM to about 180 μm, extruding a thermoplastic film, and molding the film using the cooling roll.

The abrasive may include at least one of aluminum oxides, glass beads, plastic blast media, and ceramic beads.

The cooling roll may include a rubber roll or a steel roll.

At least one of the above and other features and advantages may also be realized by providing a method of preparing a roll used for molding a film, the method including providing a roll having a surface, and abrading the surface of the roll using an airborne jet of an abrasive, the abrasive having a particle diameter of about 100 μm to about 180 μm, wherein abrading the roll using the abrasive is performed for about four to about twelve cycles.

The abrasive may include at least one of aluminum oxides, glass beads, plastic blast media, and ceramic beads.

The surface of the roll may be rubber or steel.

### BRIEF DESCRIPTION OF THE DRAWINGS

The above and other features and advantages will become more apparent to those of skill in the art by describing in detail example embodiments with reference to the attached drawings, in which:

FIG. 1 illustrates a schematic view of an operation principle of a sandblasting device according to an embodiment;

FIG. 2 illustrates a schematic view of an extrusion device where a component is extruded on a roll that has undergone a sandblasting process according to an embodiment; and

FIG. 3 illustrates a graph of a distribution of heights in the surface of a sample for defining HDI.

### DETAILED DESCRIPTION

Korean Patent Application No. 10-2007-0086601, filed on Aug. 28, 2007, in the Korean Intellectual Property Office, and entitled: “Light Diffusion Film Having Good Uniformity of Surface Roughness and Method for Manufacturing the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

An embodiment relates to a light diffusion film having an embossed pattern on at least one side of the film. The light diffusion film may exhibit good uniformity of surface roughness, with an Ra of about 0.5 μm to about 3 μm and an HDI of about 3 μm to about 8 μm. The light diffusion film may provide excellent optical characteristics and may be used in, e.g., a LCD device or other system in which a uniformly diffused light source is desired.

The light diffusion film according to an embodiment may be manufactured by extruding a melt resin through a roll, the roll having been subjected to a predetermined sandblasting process as described herein. The predetermined sandblasting process may include the use of an abrasive having a predetermined particle size. The sandblasting process may also include a predetermined number of sandblasting cycles, in which the abrasive is sprayed at the roll using, e.g., a high pressure stream of air. The roll treated using the sandblasting process may be used in an extrusion process to achieve good uniformity of surface roughness of an extruded film, thereby enabling the manufacture of a film having an excellent total transmittance and haze.

The light diffusion film manufactured according an embodiment may be a thermoplastic resin film having an embossed pattern on at least one side of the film so as to provide excellent light diffusion. The degree of embossing of the film may be evaluated using the height distribution index (HDI) and surface roughness (Ra) characteristics.

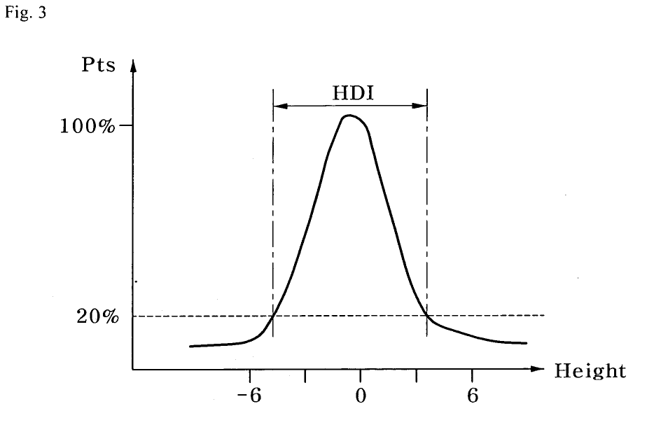

HDI, in the context of analyzing the surface roughness of a sample, is specified as a width of a range that includes a majority of distributed heights. In FIG. 3, the x-axis indicates the respective height of the surface, and the y-axis indicates the number of data points of the corresponding height. HDI specified herein is a width of a height distribution range corresponding to 20% of heights having the majority distribution within the unit area of 600×480 μm. This range can be represented as a range including a majority of distributed heights.

The light diffusion film according to an embodiment may exhibit good uniformity of surface roughness, having an Ra in a range of about 0.5 μm to about 3 μm and an HDI in a range of about 3 μm to about 8 μm, and may thereby provide excellent optical characteristics.

Maintaining the Ra and HDI values within the above-described ranges may help ensure that the light diffusion film exhibits sufficient haze. Further, maintaining the Ra and HDI values below the upper values of the above-described ranges may help ensure that the total transmittance is not unduly degraded, and may avoid deviation in film characteristics or penetration of the film. In an implementation, the light diffusion film having the Ra and HDI in the above-described ranges may provide 88% or more of ideal total transmittance and 70% or more of haze. In an implementation, the light diffusion film having the Ra and HDI in the above-described ranges may provide 91% or more of ideal total transmittance and 80% or more of haze.

Preferably, the light diffusion film has a thickness of about 60 μm to about 450 μm. Maintaining a thickness of about 60 μm or more may help ensure that the film is not so thin that it easily curls. Maintaining a thickness of about 450 μm or less may help ensure that a thickness of a backlight unit that includes the film is sufficiently low to be usable in a thin LCD device. Furthermore, if the light diffusion film is laminated on upper and lower surfaces of a brightness-improving lamination film, a sufficient thickness may also lead to the same advantages as above.

Preferably, the resin used for manufacturing the light diffusion film includes a thermoplastic resin. The thermoplastic resin may be any thermoplastic resin suitable for extrusion molding. Suitable thermoplastic resins, which may be used alone or in combination, include polyacetal resins, acrylic resins, polycarbonate resins, styrene resins, polyester resin, vinyl resins, polyphenylene ether resins, polyolefin resins, acrylonitrile-butadiene-styrene copolymer resins, polyarylate resins, polyethersulfone resins, polyphenylene sulfide resins, and fluorinated resins. Preferably, transparent polymer resins such as methacrylic resins, styrene resins, cycloolefin resins, or polycarbonate resins are used, considering the physical properties of the thermoplastic resin composition and types of products to which the resin is applied. Two or more resins may be used, e.g., as a copolymer or in an admixture.

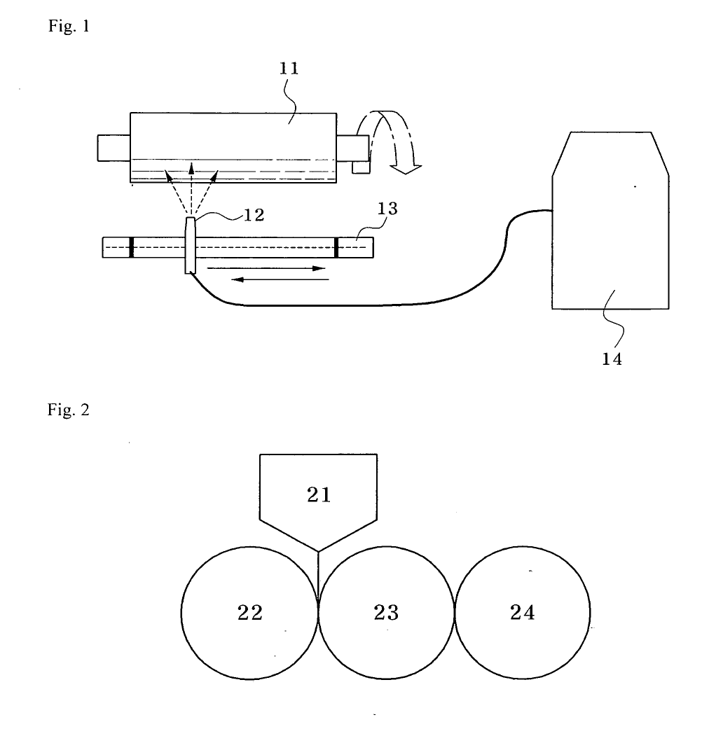

FIG. 1 illustrates a schematic view of an operation principle of a sandblasting device according to an embodiment. Referring to FIG. 1, a cooling roll 11 may be rotated and sprayed with an abrasive through an abrasive injection nozzle 12. The abrasive injection nozzle 12 may be moved back and forth along the cooling roll 11 on a left/right moving frame 13. The abrasive may be supplied to the abrasive injection nozzle 12 from an abrasive storage tank 14.

In the sandblasting process, various factors including the type and size of abrasive, the diameter of the nozzle, nozzle movement speed, roll rotation speed, injection pressure, treatment frequency, and the like, may affect surface roughness. Of these, the most important factors may be the size of abrasive and number of treatments. In the embodiments described herein, these factors are controlled to realize the desired Ra and HDI.

Examples of the abrasive include aluminum oxides, glass beads, plastic blast media, or ceramic beads. Among these, aluminum oxides or ceramic beads are preferably used to realize the desired roughness.

The abrasive preferably has a particle diameter of about 100 to about 180 μm. Maintaining the particle diameter of the abrasive at about 100 μm or greater may help ensure that the Ra and HDI values of the manufactured film are sufficient. Maintaining the particle diameter of the abrasive at about 180 μm or less may help ensure that the Ra and HDI values of the manufactured film do not exceed the desired level.

Preferably, the sandblasting performed on the surface of the cooling roll 11 is performed about 4 to about 12 times. Maintaining the number of times sandblasting is performed at about 4 or more may help ensure that the Ra and HDI values do not exceed the desired level and that deviation in surface roughness between parts of the film does not occur. Maintaining the number of times sandblasting is performed at about 12 or fewer may help ensure that the Ra and HDI values reach the desired range and the amount of abrasive used is decreased, lowering costs.

The remaining factors may be controlled within the desired levels.

Specifically, the nozzle diameter may be about 2 mm to about 9 mm. The nozzle movement speed may be about 100 mm/min to about 600 mm/min. The roll rotation speed may be about 10 m/min to about 50 m/min. The injection pressure may be about 0.2 MPa to about 1 MPa. In some cases, the Ra and HDI values may be controlled within a limited range through variation of conditions rather than the ranges noted for these factors.

A method for manufacturing the light diffusion film according an embodiment is preferably by extrusion molding on a polishing roll. FIG. 2 illustrates a schematic view of an extrusion device where a component is extruded on a roll that has undergone a sandblasting process according to an embodiment. In FIG. 2, reference numerals are designated as follows: 21: die; and 22, 23 and 24: first, second and third cooling rolls, respectively.

The cooling rolls may be a rubber roll or a steel roll, and may be the same or different. In an implementation, the roll 22 may be a silicone rubber roll, the roll 23 may a steel roll subjected to sandblasting according to an embodiment, and the roll 24 may be an untreated steel roll. However, the present invention is not limited thereto. Preferably, the first roll 22 is a rubber roll because a phase difference of the film may be reduced and roll lifespan may be prolonged.

In an implementation, the steel roll 23 may be subjected to a sandblasting treatment on its surface according to an embodiment, such that the surface of the roll 23 has complementary pattern to a pattern that will be embossed on the film. In an implementation, steel roll 23 may operate in cooperation with rubber roll 22 to cool a melt resin and produce the light diffusion film having a good uniformity of surface roughness. The rubber roll 22 may also be subjected to sandblasting or surface treatment so as to give the roll 22 a pattern, e.g., an embossed pattern.

As describe above, a light diffusion film according to an embodiment may have good uniformity of surface roughness, e.g., having an Ra of about 0.5 μm to about 3 μm and an HDI of about 3 μm to about 8 μm, and my thus provide excellent optical characteristics such as desirable levels of haze and total transmittance. The film may be formed from a thermoplastic resin and may have an embossed pattern on at least one side of the film. The film may effectively diffuse and transmit light, e.g., irregular light radiated from a light source of an LCD TV, to thereby provide light of uniform brightness to the display panel. Further, reductions in brightness caused by loss of light when light is passed through the light diffusion layer may be minimized. Uniformity of light transmittance and diffusion may be provided by forming an embossed pattern on the film itself. Further, control over the formation of the embossed pattern may be provided using the fabrication method described above so as to realize uniform optical characteristics, e.g., light transmittance and diffusion, in the light diffusion film.

The following Examples and Comparative Examples are provided in order to set forth particular details of one or more embodiments. However, it will be understood that the embodiments are not limited to the particular details described.

### Examples 1 to 3

FIG. 1 illustrates a sandblasting process used as a major processing parameter in treating a roll surface. In Examples 1 to 3 below, a steel roll was treated according to the abrasive characteristics and number of treatment cycles listed in Table 1, below.

Referring to FIG. 2, a light diffusion film according to an embodiment was manufactured from a polycarbonate resin using an extruder. The extruder used a roll, which was processed by a sandblasting treatment according to Table 1, as the second cooling roll 23. The die had a width of 600 mm. As the first, second and third cooling rolls, a rubber roll 22, the roll 23 subjected to sandblasting, and a roll 24 subjected to no treatment were used, respectively. Using a polycarbonate resin of PC-110 grade, available from Chimei Corp., extrusion was carried out from the die set at 290° C. with a discharging rate of 23.4 kg/hr. The first cooling roll 22, the second cooling roll 23 and the third cooling roll 24 had a temperature of 90° C., 110° C., and 130° C., respectively.

The resultant polycarbonate light diffusion films, which were manufactured using the roll prepared according to the sandblasting process conditions of the Examples, exhibited desirable Ra and HDI values. The Ra and HDI of the light diffusion film obtained as described above were analyzed using a profile analyzer manufactured by Wyko Tyre Technology. Measurements were performed 5 times to obtain a mean value. The total transmittance and haze were measured with an NDH 5000W-Hazemeter manufactured by Nippon Denshoku Industries Co., Ltd.

The polycarbonate light diffusion films manufactured according to Examples 1 to 3 exhibited high haze and high total transmittance uniformly throughout the entire surface, with Ra in the range of about 0.5 μm to about 3 μm and HDI in the range of about 3 μm to about 8 μm.

### Comparative Examples 1 and 2

A light diffusion film was manufactured in the same manner as in the Examples, except that the second roll 23 used in extruding the resin was subjected to sandblasting using an abrasive with different particle size (see Table 1). The resultant polycarbonate light diffusion films had Ra and HDI values that were outside the Ra range of about 0.5 μm to about 3 μm and the HDI range of about 3 μm to about 8 μm. In addition, high haze and high total transmittance were not observed.

### Comparative Examples 3 and 4

A light diffusion film was manufactured in the same manner as in the Examples, except that a roll subjected to sandblasting with different treatment cycle was used as the second cooling roll 23 in the process of extruding the resin (see Table 1). The resultant polycarbonate light diffusion films had Ra and HDI values that were outside the Ra range of about 0.5 μm to about 3 μm and the HDI range of about 3 μm to about 8 μm. In addition, high haze and high total transmittance were not observed.

TABLE 1

| | Type of | Diameter of | Treatment | Ra | HDI | | Trans- |
|---|---|---|---|---|---|---|---|
| | abrasive | abrasive | cycle | (μm) | (μm) | Haze | mittance |
| Ex. 1 | Aluminum | 106 μm | 8 cycles | 0.8 | 8 | 81% | 91% |
| | oxide | | | | | | |
| Ex. 2 | Aluminum | 120 μm | 8 cycles | 1.2 | 7 | 81% | 91% |
| | oxide | | | | | | |
| Ex. 3 | Aluminum | 160 μm | 8 cycles | 1.8 | 5 | 84% | 93% |
| | oxide | | | | | | |
| Comp. | Aluminum | 60 μm | 8 cycles | 0.4 | 2 | 58% | 85% |
| Ex. 1 | oxide | | | | | | |
| Comp. | Aluminum | 220 μm | 8 cycles | 4.3 | 21 | 64% | 83% |
| Ex. 2 | oxide | | | | | | |
| Comp. | Aluminum | 106 μm | 2 cycles | 3.3 | 15 | 68% | 84% |
| Ex. 3 | oxide | | | | | | |
| Comp. | Aluminum | 106 μm | 15 cycles | 0.3 | 2 | 63% | 85% |
| Ex. 4 | oxide | | | | | | |

As described above, a light diffusion film and a method for manufacturing the same are provided. The light diffusion film may be manufactured, and/or method of manufacturing the light diffusion film may be performed, as described above and/or as modified by the teachings set forth in U.S. Patent Application Publication No. 2009/0147499 A1, which is hereby incorporated by reference in its entirety and for all purposes.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A light diffusion film, comprising:
a thermoplastic resin, wherein:
a surface of the light diffusion film has an embossed pattern thereon, and
the surface of the light diffusion film having the embossed pattern has a surface roughness (Ra) of about 0.5 μm to about 3 μm and a height distribution index (HDI) of about 3 μm to about 8 μm.

2. The film as claimed in claim 1, wherein the light diffusion film has a thickness of about 60 μm to about 450 μm.

3. The film as claimed in claim 1, wherein the light diffusion film has a haze of about 70% or greater and a total transmittance of about 88% or greater.

4. The film as claimed in claim 1, wherein the thermoplastic resin includes at least one of a methacrylic resin, a styrene resin, a cycloolefin resin, and a polycarbonate resin.

5. A method for manufacturing a light diffusion film, the method comprising:
providing a cooling roll having a sandblasted surface, the surface being sandblasted about four to about twelve times with an abrasive having a particle diameter of about 100 μm to about 180 μm;
extruding a thermoplastic film; and
molding the film using the cooling roll.

6. The method as claimed in claim 5, wherein the abrasive includes at least one of aluminum oxides, glass beads, plastic blast media, and ceramic beads.

7. The method as claimed in claim 5, wherein the cooling roll includes a rubber roll or a steel roll.

8. A method of preparing a roll used for molding a film, the method comprising:
providing a roll having a surface; and
abrading the surface of the roll using an airborne jet of an abrasive, the abrasive having a particle diameter of about 100 μm to about 180 μm, wherein abrading the roll using the abrasive is performed for about four to about twelve cycles.

9. The method as claimed in claim 8, wherein the abrasive includes at least one of aluminum oxides, glass beads, plastic blast media, and ceramic beads.

10. The method as claimed in claim 8, wherein the surface of the roll is rubber or steel.
